(19) United States
(12) Patent Application Publication
(10) Pub. No.: US 2012/0106136 A1
(43) Pub. Date: May 3, 2012

(54) THERMAL HEAT TRANSFER WIRE

(75) Inventors: Keith Scott, Livermore, CA (US); Todd Farmer, Livermore, CA (US)

(73) Assignee: BRIDGELUX, INC., Livermore, CA (US)

(21) Appl. No.: 13/291,005

(22) Filed: Nov. 7, 2011

Related U.S. Application Data
(60) Provisional application No. 61/412,754, filed on Nov. 11, 2010.

(51) Int. Cl. F21S 8/04

(52) U.S. Cl. 362/147

(57) ABSTRACT

A light fixture includes a body, a hollow arm extending out from the body, a pipe cap at a distal end of the arm, and one or more solid state light emitting devices supported by the pipe cap. The pipe cap thermally couples the one or more solid state light emitting devices to the arm.

### CROSS REFERENCE TO RELATED APPLICATIONS

This application claims priority from U.S. provisional application Ser. No. 61/412,754, filed on Nov. 11, 2010, titled “THERMAL HEAT TRANSFER WIRE,” and is incorporated herein by reference.

### BACKGROUND

1. Field

The present disclosure relates to illumination devices. More particularly, the disclosure relates to heat dissipation in elongated light fixtures using solid state light emitting devices.

2. Background

An elongated light fixture can be described as having a light source connected to a power source by use of multiple hollow arms that branch out from the center of the fixture. A chandelier is a decorative ceiling- or wall-mounted light fixture with such characteristics. Traditionally, each arm carries an incandescent or halogen lamp at its distal end. Solid state light emitting devices, such as light emitting diodes (LEDs), are attractive candidates for replacing such conventional light sources.

In addition, some types of LEDs now have higher conversion efficiencies than traditional light sources and still higher conversion efficiencies have been demonstrated in the laboratory. Finally, LEDs require lower voltages than traditional lamps and contain no mercury or other potentially dangerous materials, therefore, providing various safety and environmental benefits.

The problem is that these light fixtures do not provide an efficient means for dissipating heat generated by solid state light emitting devices, such as LEDs.

### SUMMARY

In one embodiment, a light fixture includes a body, a hollow arm extending from the body, and one or more solid state light emitting devices at a distal end of the arm. A thermally conductive wire is arranged within the arm to thermally couple the one or more solid state light emitting devices to the arm for heat dissipation.

In a second embodiment, a light fixture includes a body, an arm extending from the body, a thermally conductive wire in thermal contact with the arm, and one or more solid state light emitting devices at a distal end of the arm. The one or more solid state light emitting devices are thermally coupled to the thermally conductive wire.

In a third embodiment, a light emitting device includes one or more solid state light emitting devices configured to be mounted at a distal end of a hollow arm extending from a body of a light fixture. A thermally conductive wire is arranged with the one or more solid state light emitting devices to thermally couple the one or more solid state light emitting devices to the arm for heat dissipation.

### BRIEF DESCRIPTION OF THE DRAWINGS

FIG. 1 shows an embodiment of a light fixture including hollow arms to support solid state light emitting devices;

FIG. 2 is a conceptual cross-sectional view illustrating an example of a solid state light emitting device (LED);

FIG. 3 is a conceptual top view illustrating an example of an array of LEDs forming a light emitting element;

FIG. 4A is a conceptual top view illustrating an example of an array of LEDs coated with a phosphor to form a white light solid state light emitting device;

FIG. 4B shows a conceptual cross-section view of the solid state light emitting device of FIG. 4A;

FIG. 5A illustrates a conceptual cross-section view of an example of a thermal heat transfer wire coupled via a foil to a solid state light emitting device in a light fixture arm;

FIG. 5B illustrates a conceptual cross-section view of an example of a thermal heat transfer wire coupled via a thermally conductive filamentary sponge to a solid state light emitting device in a light fixture arm;

FIG. 5C illustrates a conceptual cross-section view of an example of a multi-filament thermal heat transfer wire coupled to a solid state light emitting device and an arm of a light fixture; and

FIG. 6 illustrates a conceptual cross-section view of a twisted wire pair with filamentary strands thermally coupled to a solid state light emitting device via a thermally conductive filamentary sponge and an arm of a light fixture.

### DETAILED DESCRIPTION

The present invention is described more fully hereinafter with reference to the accompanying drawings, in which various aspects of the present invention are shown. This invention, however, may be embodied in many different forms and should not be construed as limited to the various aspects of the present invention presented throughout this disclosure. Rather, these aspects are provided so that this disclosure will be thorough and complete, and will fully convey the scope of the present invention to those skilled in the art. The various aspects of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method.

Various aspects of the present invention will be described herein with reference to drawings that are schematic illustrations of idealized configurations of the present invention. As such, variations from the shapes of the illustrations as a result, for example, manufacturing techniques and/or tolerances, are to be expected. Thus, the various aspects of the present invention presented throughout this disclosure should not be construed as limited to the particular shapes of elements (e.g., regions, layers, sections, substrates, etc.) illustrated and described herein but are to include deviations in shapes that result, for example, from manufacturing. By way of example, an element illustrated or described as a rectangle may have rounded or curved features and/or a gradient concentration at its edges rather than a discrete change from one element to another. Thus, the elements illustrated in the drawings are schematic in nature and their shapes are not intended to illustrate the precise shape of an element and are not intended to limit the scope of the present invention.

It will be understood that when an element such as a region, layer, section, substrate, or the like, is referred to as being “on” another element, it can be directly on the other element or intervening elements may also be present. In contrast, when an element is referred to as being “directly on” another element, there are no intervening elements present. It will be further understood that when an element such as a structure is referred to as being coupled to another element, it can be directly connected to the other element or intervening elements may also be present. For example, one element may be electrically coupled to another by direct conductive connection, or there may be an intervening electrically conductive connector, a capacitive, inductive or other form of connection which provides for transmission of electrical current, power, signal or equivalents. Similarly, two elements may be mechanically coupled by being either directly physically connected, or intervening connecting elements may be present. It will be further understood that when an element is referred to as being “formed” on another element, it can be grown, deposited, etched, attached, connected, coupled, or otherwise prepared or fabricated on the other element or an intervening element.

Furthermore, relative terms, such as “lower” or “bottom” and “upper” or “top,” may be used herein to describe one element's relationship to another element as illustrated in the drawings. It will be understood that relative terms are intended to encompass different orientations of an apparatus in addition to the orientation depicted in the drawings. By way of example, if an apparatus in the drawings is turned over, elements described as being on the “lower” side of other elements would then be oriented on the “upper” side of the other elements. The term “lower”, can therefore, encompass both an orientation of “lower” and “upper,” depending of the particular orientation of the apparatus. Similarly, if an apparatus in the drawing is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this disclosure.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof The term “and/or” includes any and all combinations of one or more of the associated listed items.

The detailed description set forth below in connection with the appended drawings is intended as a description of various aspects of the present invention and is not intended to represent all aspects in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention.

Various aspects of a light fixture will now be presented. Disclosed is an apparatus and method for attaching a thermally conductive wire to a solid state light emitting device located on a thermal plate at a distal end of a light fixture arm, where the thermal plate supports a solid state light emitting device, such as an LED or LED array. LEDs are representative of one of solid state light emitting devices, and are described with reference to the various embodiments without loss of generality pertaining to solid state emitting devices.

An example of a solid state light emitting device is the light emitting diode (LED). The LED is well known in the art, and therefore, will only briefly be discussed to provide a complete description of the invention. An LED is a semiconductor material impregnated, or doped, with impurities. These impurities add “electrons” and “holes” to the semiconductor, which can move in the material relatively freely. Depending on the kind of impurity, a doped region of the semiconductor can have predominantly electrons or holes, and is referred to as n-type or a p-type semiconductor region, respectively. In LED applications, the semiconductor includes an n-type semiconductor region and a p-type semiconductor region. A reverse electric field is created at the junction between the two regions, which cause the electrons and holes to move away from the junction to form an active region. When a forward voltage sufficient to overcome the reverse electric field is applied across the p-n junction, electrons and holes are forced into the active region and combine. When electrons combine with holes, they fall to lower energy levels and release energy in the form of light.

LEDs are available in a range of colors of relatively narrow bandwidth. However, in applications where it is desirable to simulate illumination spectral properties representative of “white light” produced by incandescent, fluorescent, halogen or natural sunlight, one solution is to include one or more phosphors in a carrier encapsulating, or as a layer above, a blue LED. The phosphors absorb a portion of the short wavelength blue light and emit longer wavelengths of light by a process of Stokes shift emission. By controlling the type and amount of phosphor a balanced mix of light emitted by the LED directly and the phosphor is perceive by the human eye as “white light.”

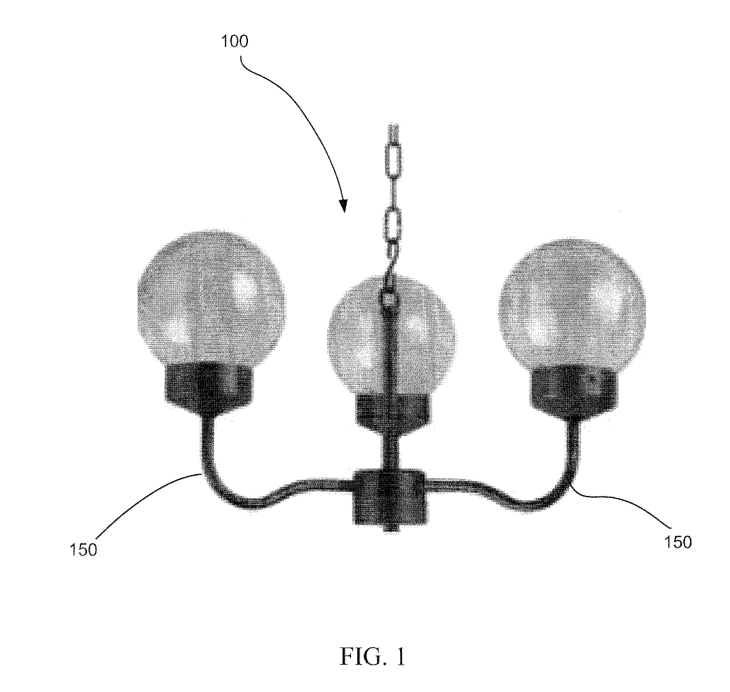

FIG. 1 shows an embodiment of a light fixture 100 including a plurality of hollow arms 150 to support solid state light emitting devices. The solid state light emitting devices are described below.

Referring to FIG. 2, the LED 201 includes a substrate 202, an epitaxial-layer structure 204 on the substrate 202, and a pair of electrodes 206 and 208 on the epitaxial-layer structure 204. The epitaxial-layer structure 204 comprises an active region 216 sandwiched between two oppositely doped epitaxial regions. In this example, an n-type semiconductor region 214 is formed on the substrate 202 and a p-type semiconductor region 218 is formed on the active region 216, however, the regions may be reversed. That is, the p-type semiconductor region 218 may be formed on the substrate 202 and the n-type semiconductor region 214 may formed on the active region 216. As those skilled in the art will readily appreciate, the various concepts described throughout this disclosure may be extended to any suitable epitaxial-layer structure. Additional layers (not shown) may also be included in the epitaxial-layer structure 204, including but not limited to buffer, nucleation, contact and current spreading layers as well as light extraction layers.

The electrodes 206 and 208 may be formed on the surface of the epitaxial-layer structure 204. The p-type semiconductor region 218 is exposed at the top surface, and therefore, the p-type electrode 206 may be readily formed thereon. However, the n-type semiconductor region 214 is buried beneath the p-type semiconductor region 218 and the active region 216. Accordingly, to form the n-type electrode 208 on the n-type semiconductor region 214, a portion of the active region 216 and the p-type semiconductor region 218 is removed to expose the n-type semiconductor region 214 therebeneath. After this portion of the epitaxial-layer structure 204 is removed, the n-type electrode 208 may be formed.

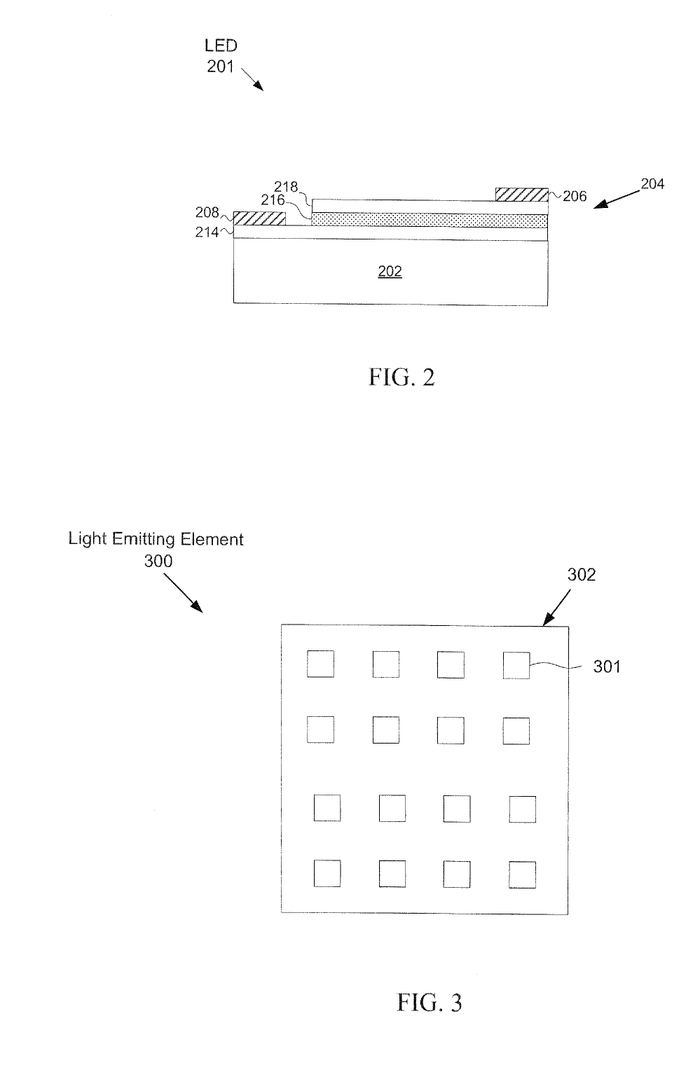

As discussed above, one or more light emitting devices may be used to construct an LED array. One example of an LED array will now be presented with reference to FIG. 3. FIG. 3 is a conceptual top view illustrating an example of an LED array. In this example, an LED array 300 is configured with multiple LEDs 301 arranged on a substrate 302. The substrate 302 may be made from any suitable material that provides mechanical support to the LEDs 301. Preferably, the material is thermally conductive to dissipate heat away from the LEDs 301. The substrate 302 may include a dielectric layer (not shown) to provide electrical insulation between the LEDs 301. The LEDs 301 may be electrically coupled in parallel and/or series by a conductive circuit layer, wire bonding, or a combination of these or other methods on the dielectric layer.

The LED array may be configured to produce white light. White light may enable the LED array to act as a direct replacement for conventional light sources used today in incandescent, halogen, fluorescent, HID, and other suitable lamps. There are at least two common ways of producing white light. One way is to use individual LEDs that emit wavelengths (such as red, green, blue, amber, or other colors) and then mix all the colors to produce white light. The other way is to use a phosphor material or materials to convert monochromatic light emitted from a blue or ultra-violet (UV) LED to broad-spectrum white light. The present invention, however, may be practiced with other LED and phosphor combinations to produce different color lights.

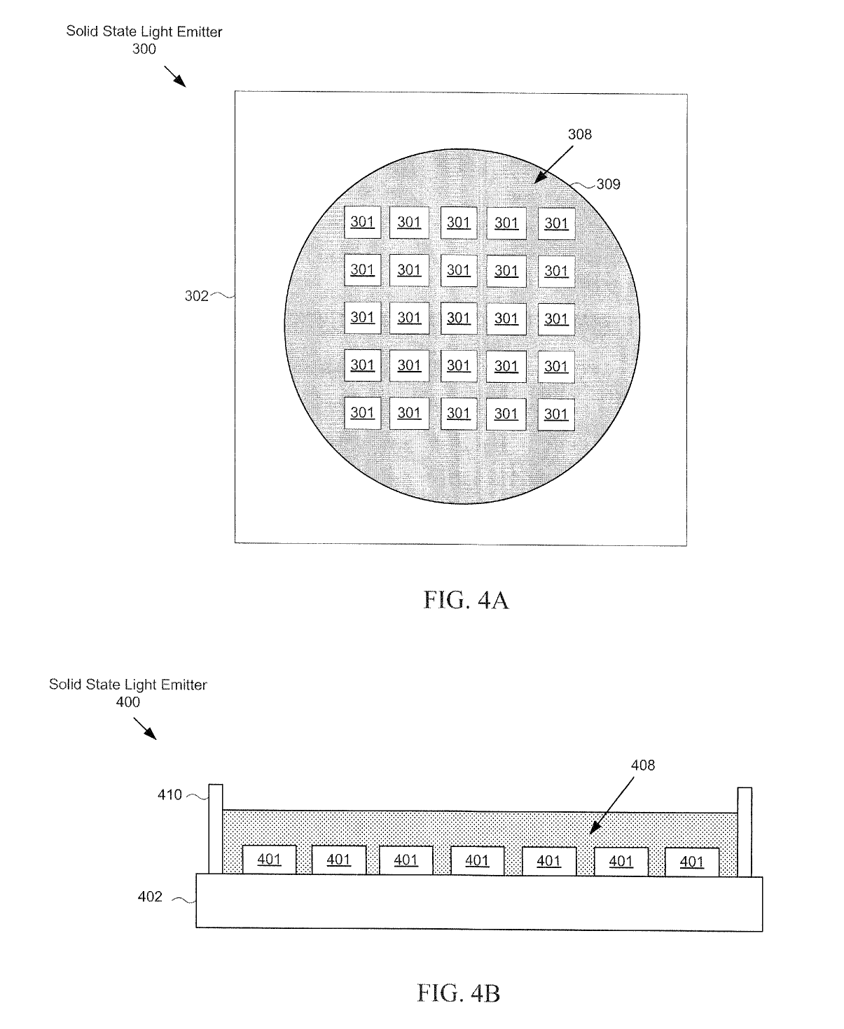

An example of a LED array will now be presented with reference to FIGS. 4A-4B. FIG. 4A is a conceptual top view illustrating an example of a white light LED array, now referred to as a solid state light emitting device 400 and FIG. 4B is a conceptual cross-sectional side view of the solid state light emitting device 400 in FIG. 4A. The solid state light emitting device 400 is shown with a substrate 402 which may be used to support multiple LEDs 401. The substrate 402 may be configured in a manner similar to that described in connection with FIG. 3 or in some other suitable way. In this example, the substrate 402 includes a plurality of slots 410 along the periphery. A phosphor material 408 may be deposited within a cavity defined by an annular, or other shaped, or other boundary 409 that extends circumferentially, or in any shape, around the upper surface of the substrate 402, as may be determined, for example, by the slots 410. The annular boundary 409 may be formed with a suitable mold, or alternatively, formed separately from the substrate 402 and attached to the substrate 402 using an adhesive or other suitable means. The phosphor material 408 may include, by way of example, phosphor particles suspended in an epoxy, silicone, or other carrier or may be constructed from a soluble phosphor that is dissolved in the carrier.

In an alternative configuration of a white light emitting element, each LED 401 may have its own phosphor layer. As those skilled in the art will readily appreciate, various configurations of LEDs and other light emitting devices may be used to create a white light emitting element. Moreover, as noted earlier, the present invention is not limited to solid state lighting devices that produce white light, but may be extended to solid state lighting devices that produce other colors of light.

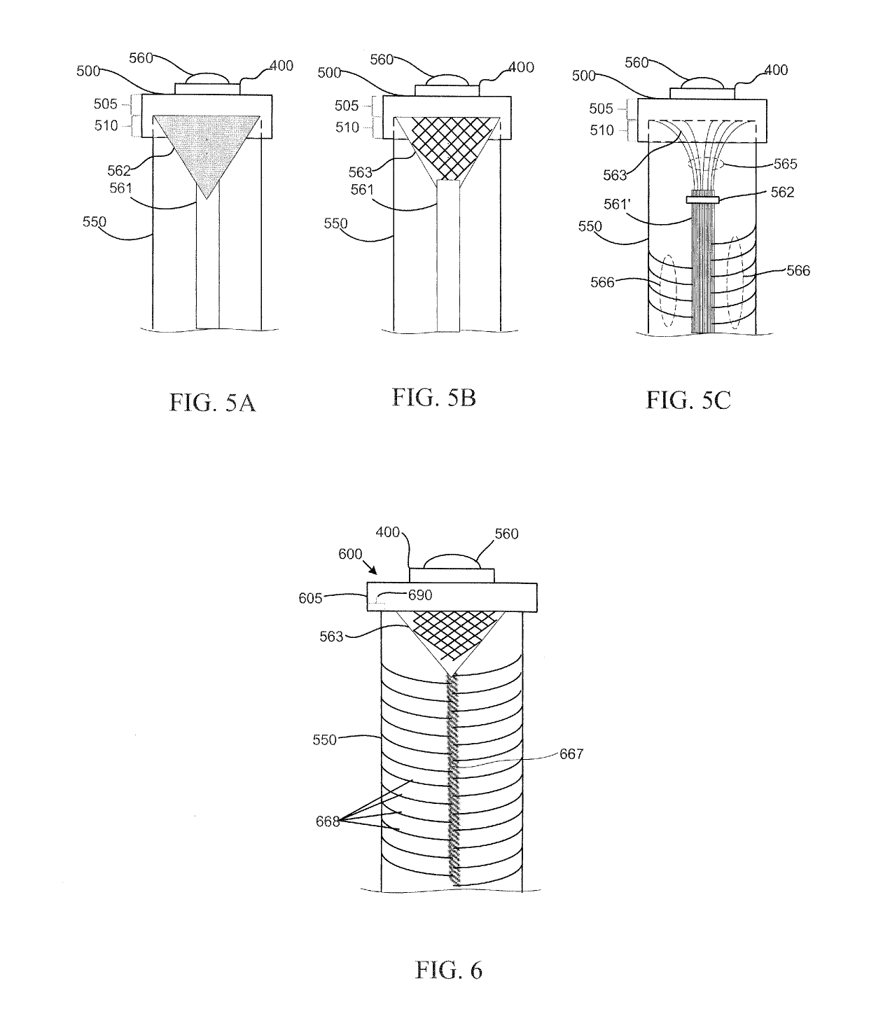

Referring to FIG. 5A, a solid state light emitting device 400 may be attached to a thermally conductive plate 500. The plate 500 may be mounted to the distal end of an arm 550 to provide a thermal path between the solid state light emitting device 400 and the arm 550. The plate 500 may be configured to carry optics 560 that work together with the solid state light emitting device 400 to obtain a specified illumination pattern. The plate 500 may be formed as a disk 505 that supports the solid state light emitting device 400 and optics 560. The disk 505 may be circular, oval or polygonal in order to suitably couple to the arm 550.

An environmentally protective feature 590 may be placed over the solid state emitting device 400 to protect against various environmental elements that may degrade the performance of the solid state emitting device 400. The feature 590 may be attached to the solid state emitting device 400, the pipe cap 500, the arm 550, or any combination thereof. The feature 590 may be at least one of a sealed transparent cap, a translucent cap, a screen, or the like, and any combination thereof, to protect the solid state emitting device 400 from moisture, objects, insects and creatures, or the like.

The plate 500 may attach to the arm 550 in various ways. The plate 500 may comprise a cap including the disk 505 and a cylindrical portion 510 that fits over the arm 550. Alternatively, the plate may include the disk 505 without a cylindrical portion 510.

A wire 561 for thermally conducting heat from the plate 500, in addition to the path directly between the plate 500 and the arm, may be coupled to the plate 500 in various ways. The wire may extend the entire length of the arm 550, from approximately the plate 500 at the distal end to the proximal end of the arm 550. In one embodiment, a thermally conductive foil 562, which may optionally be shaped as a cone, as shown for illustrative purposes, may couple the thermally conductive wire to the plate 500. In an alternative embodiment, as shown in FIG. 5B, a thermally conductive fishnet (or sponge-like) structure 563, which may optionally be shaped as a cone, as shown for illustrative purposes, may couple the thermally conductive wire 561 to the plate 500. The thermally conductive wire 561 may be a single wire, or it may optionally be a plurality of wire strands (not shown) which are thermally coupled to the fishnet/sponge structure 563, which in turn is thermally coupled to the plate 500.

In another embodiment, as shown in FIG. 5C, the end of the thermally conductive wire may be a multi-filament wire 561′ that comprises the wire filaments 565 frayed and attached to the plate 500 at a plurality of contact points by the individual wire filaments 565. One or more containment rings 562 may be used to contain the multi-filament wire 561′ to prevent unraveling.

A plurality of filaments 566 may extend from the wire 561 or 561′ to make contact with an inner wall surface of the arm 550, thus forming a plurality of thermal paths along the length of the wire 561/561′ to the arm, to utilize the surface area of the arm 550 for heat dissipation.

In an embodiment, as shown in FIG. 6, a thermally conductive wire may include a twisted wire pair 667 of wires, and each of the wires of the wire pair 667 may be a single strand of wire, or a multi-filament wire. In one example, additional wire filament strands 668 may be entwined in the twisted pair of wires 667 to extend laterally from the length of the wire pair, giving the appearance of a “bottle brush” over an extended length of the wire pairs 667. Thus, a large number of thermal paths from the plate 500 to the arm 550 are formed.

In the example shown in FIG. 6, the wire pair 667 is shown as terminating in the thermally conductive fishnet (or sponge-like) structure 563 for thermal coupling to a plate 605. However, in other embodiments, the wire pair 667 may terminate in the foil 562, as shown in FIG. 5A, or if the twisted wire pair comprised multi-filament wires 565, the multi-filament wires 565 may be frayed and coupled to the plate 505 as shown in FIG. 5C and attached according to the various adhesive methods discussed above.

The wire 561, 561′, 667 and lateral filaments 668 may be made of a relatively high thermal conductivity material. Aluminum, copper, and silver, are example of metals having thermal conductivity properties useful in heat dissipation, but other metals and non-metals having similar thermal properties may be used.

The thermal wire 561, 561′, 667 may be installed by inserting from a proximal end to the distal end of the arm 550, attaching the thermal wire to the plate 505 or 605, and then pulling the wire back. In such a method of assembly, the lateral filaments 668 may be of such length that they are biased and become spring loaded against the wall of the arm 550 to enhance the loading force that brings the lateral filaments 668 in still better thermal contact with the arm 550.

Various forms of adhesion may be used to mechanically and thermally couple the thermal wire 561, 561′, 667 to the plate 500, including thermally conductive epoxy paste, solder, spot welding, and the like. Thermally conductive grease may be applied to the inside wall of the arm 550 to improve thermal conductivity between the lateral filaments 668 and the arm 550.

The plate 500 may attach to the arm 550 in various ways. The plate 500 may be adhesively attached to the arm with thermally conductive adhesive. Alternatively, the plate 500 may be shaped to press fit inside or over the distal end of the arm 550. Additional attachment means may be considered, including a snap fit structure or screw thread between the plate 500 and arm 550.

Example embodiments in accordance with aspects of the present invention have now been described in accordance with the above advantages. It will be appreciated that these examples are merely illustrative of aspects of the present invention. Many variations and modifications will be apparent to those skilled in the art.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” For example, whereas examples are described with respect to a single arm of a light fixture, the description and claims encompass a light fixture including a plurality of arms. Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A light fixture, comprising:
a body;
a hollow arm extending from the body;
one or more solid state light emitting devices at a distal end of the arm; and
a thermally conductive wire arranged within the arm to thermally couple the one or more solid state light emitting devices to the arm.

2. The light fixture of claim 1 wherein the thermally conductive wire extends substantially through the entire arm.

3. The light fixture of claim 1 further comprising a thermally conductive plate at the distal end of the arm to support the one or more solid state light emitting devices.

4. The light fixture of claim 3 further comprising one or more optics supported by the thermally conductive plate.

5. The light fixture of claim 3 wherein the thermally conductive wire extends substantially through the entire arm from the thermally conductive plate to a proximal end of the arm.

6. The light fixture of claim 3 further comprising a thermally conductive foil attaching the thermally conductive wire to the thermally conductive plate.

7. The light fixture of claim 3 further comprising a thermally conductive fishnet structure attaching the thermally conductive wire to the thermally conductive plate.

8. The light fixture of claim 3 wherein the thermally conductive wire is frayed at one end, and wherein the frayed end of the thermally conductive wire is attached to the thermally conductive plate at a plurality of points.

9. The light fixture of claim 8 further comprising a containment ring around the frayed end of the thermally conductive wire.

10. The light fixture of claim 1 wherein the thermally conductive wire comprises a plurality of thermally conductive strands.

11. The light fixture of claim 1 wherein the thermally conductive wire comprises a twisted pair of thermally conductive strands.

12. The light fixture of claim 1 wherein the thermally conductive wire comprises a core extending through the arm and a plurality of strands extending from the core to the arm.

13. The light fixture of claim 12 wherein the strands are spring loaded.

14. The light fixture of claim 12 wherein the strands provide a thermal conduction path to the outer shell of the fixture arm.

15. The light fixture of claim 1 further comprising an environmentally protective feature supported by the arm.

16. The light fixture of claim 3, wherein the protective feature is at least one of a sealed transparent cap, a sealed translucent cap, and a screen.

17. A light emitting device, comprising:
one or more solid state light emitting devices configured to be mounted at a distal end of a hollow arm extending from a body of a light fixture; and
a thermally conductive wire arranged with the one or more solid state light emitting devices to thermally couple the one or more solid state light emitting devices to the arm.

18. The light emitting device of claim 17 wherein the thermally conductive wire is configured to extend substantially through the entire arm when the one or more solid state light emitting devices are mounted to the distal end of the arm.

19. The light emitting device of claim 17 further comprising a thermally conductive plate to support the one or more solid state light emitting devices.

20. The light emitting device of claim 19 further comprising one or more optics for the one or more solid state light emitting devices, the one or more optics being supported by the thermally conductive plate.
